(19) United States
(12) Patent Application Publication
(10) Pub. No.: US 2012/0191686 A1
(43) Pub. Date: Jul. 26, 2012

(54) System and Method for Assisting a User with Searching Multimedia Objects

(75) Inventors: Johan Hjelm, Tokyo (JP); Olle Eriksson, Stockholm (SE)

(73) Assignee: TELEFONAKTIEBOLAGET L M ERICSSON (PUBL), Stockholm (SE)

(21) Appl. No.: 13/393,629

(22) PCT Filed: Oct. 7, 2009
(86) PCT No.: PCT/JP2009/067820

§ 371 Date: Mar. 1, 2012

(51) Int. Cl. G06F 17/30

(52) U.S. Cl. 707/706; 707/E17.108

(57) ABSTRACT

A system for assisting a user with searching multimedia objects through one or more search engines is provided. The system includes a collection unit for collecting user information, the user information including at least one of context information associated with a user device and usage information associated with actions taken by a user of the user device, a computation unit for computing statistics based on the collected user information, a reception unit for receiving a multimedia object from a content provider, a creation unit for creating meta-information based on the computed statistics and the received multimedia object, the meta-information used for the one or more search engines to index the received multimedia object, and a response unit for responding the created meta-information to the content provider.

### TECHNICAL FIELD

The present invention relates to a system and method for assisting a user with searching multimedia objects.

### BACKGROUND

Today, search engines exist which enable searching for information in a media set. The search engines often work by analyzing the meta-information describing the objects of the media set (for example, “tags”), and comparing the media set to a query submitted by an end-user through a web form. Several famous such techniques exist on the World Wide Web.

Standardization in the Open Mobile Alliance is ongoing on a framework for searching for information using a mobile phone as terminal (the OMA REQ MobSrchFramework AHG). In addition, techniques exist, and have been long established, for capturing information about the user, the device the user is using, and other similar relevant information. Evidence of this is standards such as OMA DPE, which enables the capture and transmission of device profile information; and W3C Delivery Context, which enable the capture and transmission of additional contextual information. A mechanism to collate and share this context information is currently being standardized in the OMA REQ/CD CPNS AHG.

It is useful to distinguish between “device capabilities”, which are representations of the technical resources which are installed in a device (e.g. renderer software, screen, and so on); and other “context information” which is further enhanced by information relating to the user, for instance position, preferences for the usage of device capabilities (one codec over another, one input modality over another). The context information relating to the user can be collected from other sources than the device, e.g. positioning in the network. Device capabilities can also be retrieved from a central database, as is done in DPE and W3C Delivery Context using WURFL.

Context information can be used to draw conclusions about a users situation—the statement “IF the Sun is shining AND it is my vacation, THEN show me the way to the beach; IF it is raining, show me the way to a museum” can be used to enable a context-based search.

This way of using context information is analogous to the way advertising personalization works. In this case, the personal profile, which contains e.g. the position information, is equivalent to the context information, and the matching of advertising to preferences, demographics, and other relevant data is done using the same techniques as the matching of context data.

A further relevant parameter is the collection of usage information. The information about how the user actually uses a device can be collected from probes like the UPnP probe, and other similar methods, for instance, in SIP devices, by looking in the registry; or in HTTP proxies, by analyzing log files. This gives an indication of how users actually use devices.

Currently, there is an assumption amongst developers that the context information is individualized, i.e. that the services provided should be personalized, for example, as in the personalized TV advertising case. Furthermore, there is an assumption that web pages are static, even though they in practice are generated from a database by scripts.

Hence, the indexing of web pages essentially treat the pages presented to the search engine as static pages, which means they are adapted to the search engine crawler, but a user who does a search later will not get an adapted page unless they access the actual web site itself.

The same is, as was noted above, true for advertising. This is a significant problem for the industry, in particular the mobile industry, since advertising is not adapted to the actual user but generic, and hence less interesting and less likely to be read. This is particularly true for keyword advertising, which will not be clicked on by the user if it is not interesting. Since the limited screen space will make it likely for the foreseeable future that mobile advertisements will be of the keyword-advertising type, personalization will be even more important to make the user feel the advertisements are interesting and not an irritant.

A further problem is presented by the usage information. The usage information is highly sensitive information, and it is unlikely (and may not be allowed in some legislatures) that users will want this information to be used by the service provider to tailor information to the users. Hence, mechanisms to anonymize this information, as well as protect the parameters the user does not want to give out, are important.

### SUMMARY

According to an aspect of the invention, a system for assisting a user with searching multimedia objects through one or more search engines is provided. The system includes a collection unit for collecting user information, the user information including at least one of context information associated with a user device and usage information associated with actions taken by a user of the user device, a computation unit for computing statistics based on the collected user information, a reception unit for receiving a multimedia object from a content provider, a creation unit for creating meta-information based on the computed statistics and the received multimedia object, the meta-information used for the one or more search engines to index the received multimedia object, and a response unit for responding the created meta-information to the content provider.

According to another aspect of the invention, a method for assisting a user with searching multimedia objects through one or more search engines is provided. The method includes the steps of collecting user information, the user information including at least one of context information associated with a user device and usage information associated with actions taken by a user of the user device, computing statistics based on the collected user information, receiving a multimedia object from a content provider, creating meta-information based on the computed statistics and the received multimedia object, the meta-information used for the one or more search engines to index the received multimedia object, and responding the created meta-information to the content provider.

Further features of the present invention will become apparent from the following description of exemplary embodiments with reference to the attached drawings.

### BRIEF DESCRIPTION OF DRAWINGS

FIG. 1 illustrates an exemplary environment 10 including a system 100 according to an embodiment of the present invention.

FIG. 2 illustrates an exemplary block diagram of the PNAS 103 according to this embodiment.

FIG. 3 illustrates an exemplary block diagram of the STOS 104 according to this embodiment.

FIG. 4 illustrates an example of overall operations of the system 100 according to this embodiment.

### DETAILED DESCRIPTION

Embodiments of the present invention will now be described with reference to the attached drawings. Each embodiment described below will be helpful in understanding a variety of concepts from the generic to the more specific. It should be noted that the technical scope of the present invention is defined by claims, and is not limited by each embodiment described below. In addition, not all combinations of the features described in the embodiments are always indispensable for the present invention.

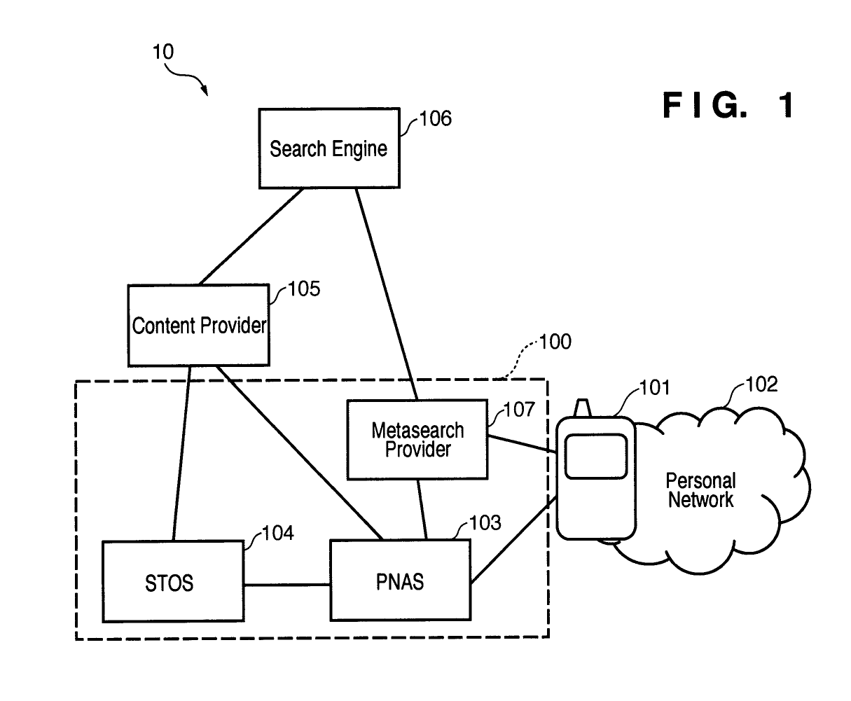

FIG. 1 illustrates an exemplary environment 10 including a system 100 according to an embodiment of the present invention. The environment 10 includes a user device 101 in a personal network 102, a PNAS (Personal Network Application Server) 103, an STOS (Semantic Tag Optimization Server) 104, a content provider 105, a search engine 106, and a metasearch provider 107. Although only one user device 101, one content provider 105, and one search engine 106 are shown in FIG. 1 for simplicity, the environment 10 may include a number of personal networks, content providers, and search engines.

The user device 101 is a device which a user uses for searching multimedia objects. For example, the user device 101 is a mobile terminal, a personal computer, a PDA, and so on. The user device 101 may be a personal network gateway. In particular where the user is using the personal network 102 of less capable devices through a gateway, the situation will be the same with regards to the need to adapt the presented information to the user. In case of that the user device 101 is a mobile terminal, the user information collected is available from sources in the mobile network. However, the system 100 will work equally well in a fixed network, provided the same type of user information is made available to the PNAS 103. This can be done using a variety of different standards, e.g. Parlay.

The user device 101 has user information including at least one of context information and usage information. The context information is a description of the user situation from the viewpoint of the user device 101. For example, the context information contains static device capabilities such as input method(s), camera available, camera pixel resolution, screen size; dynamic device capabilities such as battery lifetime, background lighting on/off; environmental context parameters such as location, temperature; and personal parameters such as user profile, selection. The usage information is information associated with actions taken by the user of the user device 101. For example, the usage information contains listening to songs or watching media files, storing of specific types or groups of songs or media files in playlists, taking photographs, and recording audio or video files.

The user information may be represented as structured text, in particular through the use of XML, which makes the user information machine-readable and possible to interpret automatically by a computer such as the PNAS 103. When creating a structured representation of the user information, the XML elements (represented as “tags”) makes it possible for the computer to deduce the type of the data from the encoding, by referencing a schema which declares the type of the data, etc. In addition, these tags may contain additional information that enables the computer to deduce the relationship between elements, such as the RDF (Resource Description Format) graph. When using RDF, the structure of the elements expresses what properties a parameter has, and hence how it is related to other parameters. This means that it is possible not just to deduce the data type, but also e.g. ranges. This can then be further used to draw conclusions about the material represented. For example, the “battery is between 50 and 60” could be related to “to play the following video, the battery consumption is 80”, which when related to the declared range may mean that the computer could conclude that it could not play the video, based on the provided information.

The PNAS 103 collects and manages the user information. The PNAS 103 may collect the user information from e.g. presence, from location servers, and from other sources such as sensors in addition to the user information directly delivered from the user device 101. In addition, the PNAS 103 computes user statistics from the collected user information. The user statistics may be represented as ranges, and may include probabilities on the ranges.

The PNAS 103 may respond to queries for the user information in the same way as the DPE server is specified to do so in OMA DPE. However, the user information, especially the usage information and other information which relates to the individual, is usually considered sensitive. Hence, the user information needs to be protected from being given out to unauthorized parties. This protection may be in the form of a policy which is applied to the user information so that information which the user does not wish to give out is filtered out, and it can be in the form of anonymization by means of using user statistics instead of individual user information. The PNAS 103 may collect the user information from more than one user device. The more user devices whose user information is aggregated and collated, the more the individual user is protected.

The STOS 104 receives a multimedia object from a content provider 105 and creates meta-information based on the received multimedia object. The multimedia object is provided with the user of the user device 101 and an example of the multimedia object is a web page. The meta-information is used for the search engine 106 to index the multimedia object. The meta-information is, for example, a tag set, metadata document, and scripts. In this embodiment, pages are used as multimedia objects and tag sets are used as meta-information.

The STOS 104 leverages the user statistics in the PNAS 103 to create optimized meta-information, and then responds the created meta-information to the content provider 105.

The content provider 105 provides pages with the user of the user device 101. The content provider 105 uses the received tag set(s) to create a set of optimized pages.

The search engine 106 crawls pages of content providers and then indexes the information in the normal way, by running the pages through an indexer. The search engine 106 may cache the pages.

The invention described in this document can work without modifications to the search engine 106, that is, can be transparently applied when the search engine 106 indexes the pages provided by the content provider 105.

The metasearch provider 107 retrieves the pages from a number of search engines, and compares the pages to the user's context retrieved from the PNAS 103. The metasearch provider 107 also makes other filtering for the information, like removing duplicates and other information. Additional adaptations may also be performed, in addition to the selection of the pages in the list of search results according to the user's context. The list of retrieved pages is then returned to the user device 101. The metasearch provider 107 is optional. The user of user device 101 may request a search to the search engine 106 directly. In this case, the search engine 106 returns the found pages to the user device 101 directly.

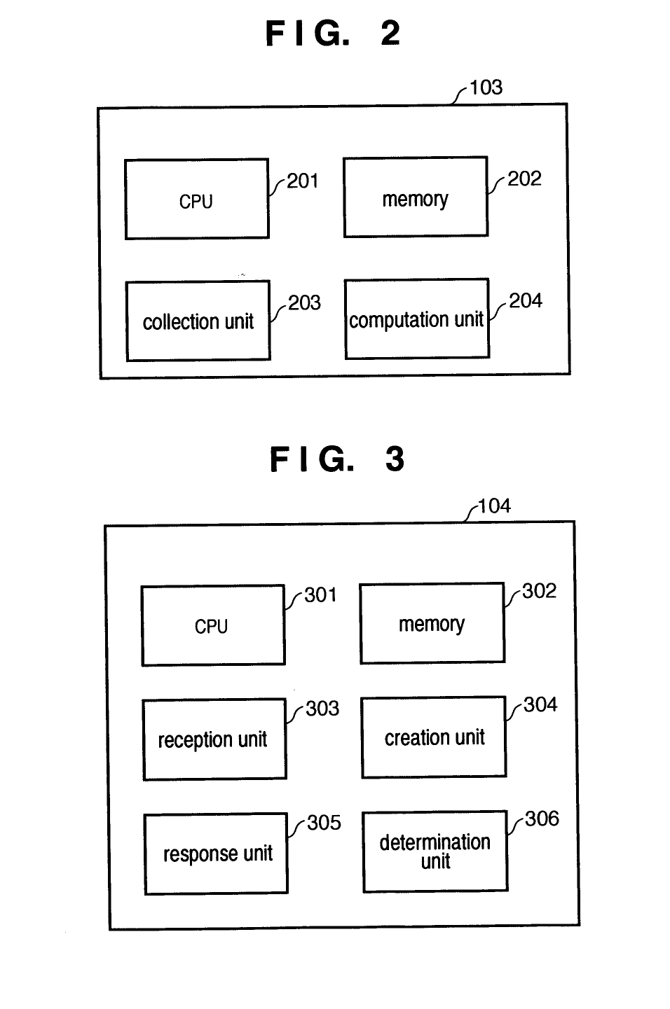

FIG. 2 illustrates an exemplary block diagram of the PNAS 103 according to this embodiment. The PNAS 103 includes a CPU 201, a memory 202, a collection unit 203, and a computation unit 204. The CPU 301 controls overall operations of the PNAS 103. The memory 202 stores computer programs and data used for operations of the PNAS 103. The collection unit 203 collects and manages the user information. The computation unit 204 computes user statistics based on the collected user information

FIG. 3 illustrates an exemplary block diagram of the STOS 104 according to this embodiment. The STOS 104 includes a CPU 301, a memory 302, a reception unit 303, a creation unit 304, a response unit 305, and a determination unit 306. The CPU 301 controls overall operations of the STOS 104. The memory 302 stores computer programs and data used for operations of the STOS 104. The reception unit 303 receives a page to be optimized from a content provider 105. The creation unit 304 creates a tag set based on the computed user statistics and the received page. The response unit 305 responds the created tag set to the content provider 105. The determination unit 306 determines typical contexts. The determination unit 306 may be included in the content provider 105 or the PNAS 103 instead of in the STOS 104. The PNAS 103 and the STOS 104 may be implemented as a single server.

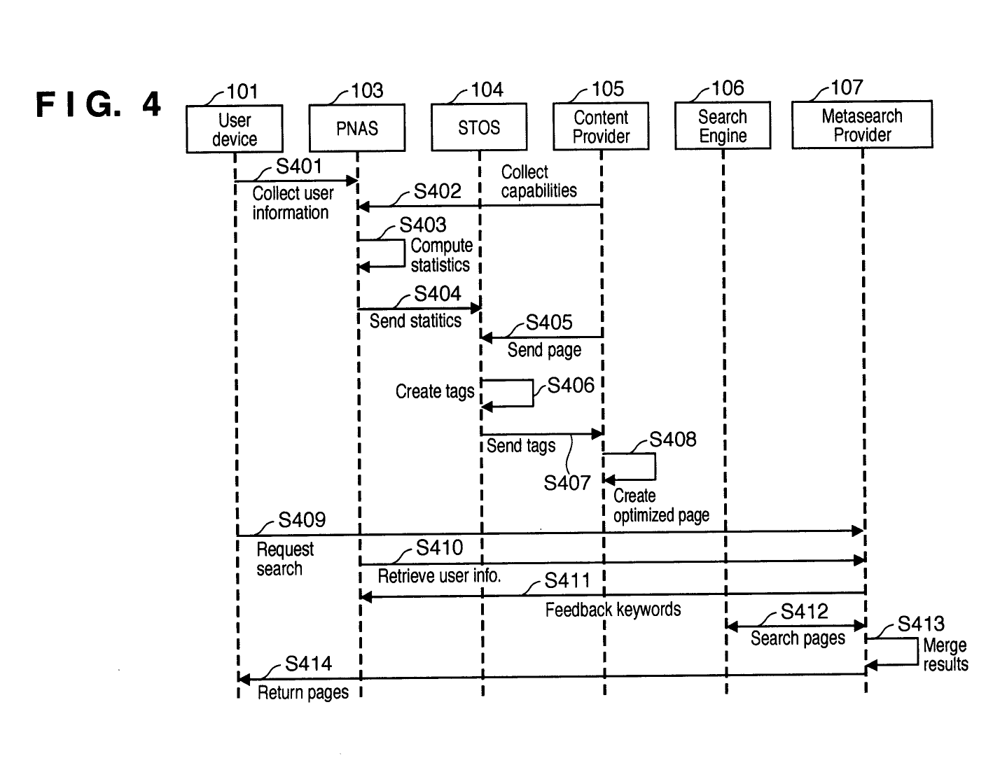

FIG. 4 illustrates an example of overall operations of the system 100 according to this embodiment. The CPU included in each apparatus executes computer programs stored in memory of each apparatus to process these operations.

In step S401, the collection unit 203 collects the user information. The user device 101 may report own user information to the PNAS 103. In step S402, the PNAS 103 may also collect capabilities of the content provider 105. The capabilities of the content provider 105 include, for example, the supported language for expressing optimization.

In step S403, the computation unit 204 computes the user statistics based on the collected user information. The computation unit 204 may compute the user statistics in “raw” format or as statistics which are semi-processed. The user statistics are formatted to be easily matchable with the capabilities of the content provider 105, and the tag set, as well as keywords from the metasearch provider 107.

The computation of the user statistics may be executed after a request from the STOS 104 in step S405, or may be executed as a result of a subscription. Either can be triggered automatically, for instance by a page being updated, or triggered by an active request of the STOS 104.

In step S404, the creation unit 304 requests and receives the user statistics from the PNAS 103. The user statistics may depend on the user information sought, for example, in terms of the area where the user statistics are usable, and the user statistics may be aggregated to represent a time series, or other means. In step S405, the reception unit 303 receives a request for the tag set from the content provider 105. The request includes a page to be optimized. The request may include the content of the page instead of the page itself.

In step S406, the creation unit 304 creates a tag set based on the user statistics received at step S404 and the page received at step S405. To assist the creation of the tag set, the determination unit 306 may determine typical contexts based on the user statistics. The typical contexts are the most frequent contexts in the statistics. The determination of the typical contexts may be performed by comparing the ranges of the different parameters over time series, and determining which values of which parameters are most applicable during which time periods.

The typical contexts may be determined based on either the absolute frequency, or a relative frequency related to a particular item in the user information, such as related to a particular device, or a particular location, or a relative frequency related to a particular combination of items in the user information, such as presence status and velocity of the user device 101. For example, the user of the user device 101 may be in a silent section in a high-speed train closing in on Tokyo, or location and recently played songs, or the user may be waiting for a concert by a specific rock band or something similar. The information about what contexts are most relevant can be computed from the information about the contexts used in requests for information. Hence, the typical context is not individualized per user, but less fine-grained, yet still representing typical contexts.

The typical contexts may be represented dynamically, as an aggregate of their parameters. The typical contexts may be represented by reference, by a URI or a set of coordinates for example, or some other means. The main thing is that the typical context identification is shared between the content provider 105 and the STOS 104.

Special attention is given to parameters and values which are pertinent in creating versions which are affected by contextual information. Examples include form factor over time and position (who watches what with mobile devices when and where); other parameters which behavior has dependencies on (such as temperature, external events). Special attention may imply given additional weight to the processing of the pertinent parameters and values. The creation unit 304 may also take the content providers capabilities into account, for example, how much data the content provider 105 can handle.

The creation unit 304 analyzes the page and checks which context-related parameters are relevant and how they should affect the page. The rules for this are part of the logic of the creation unit 304. This may imply translating a generic tag set into a specialized ontology or similar format.

In cases where the content provider 105 is generating pages from a database, the reception unit 303 may not receive the pages, but rather the database schema, or other representation of the database which the STOS 104 can leverage in generating the appropriate versions. In this case, the creation unit 304 may also create the scripts (e.g. PHP scripts) rather than the tag set for the pages, and provide the scripts to the content provider 105, potentially depending on the information the content provider 105 has provided about itself.

The creation unit 304 may also determine which form factor the content should be adapted for, which tag set should be applied, and which typical contexts these formatting rules applies to. The content (e.g. XHTML) and the formatting (e.g. CSS) are computed independently of each other, and the tag set may be embedded in the XHTML. If the typical context implies special formats, such as mobile pages, adapted versions for this can also be created, e.g. in WML, by applying a set of XSLT transformations to the XHTML.

To create the tag set, the creation unit 304 may make a request to the PNAS 103 for the capabilities of the content provider 105. The capabilities of the content provider 105 include, for example, information about which languages for search engine optimization which the content provider 105 supports. The creation unit 304 may further use the capabilities of the content provider 105 to format the response of the tag set. The access to the STOS 104 may be dependent on supporting certain search engine optimization languages. The STOS 104 may format information in different languages, depending on the tag set. This includes, for example, generating PHP scripts.

In step S407, the response unit 305 responds the created tag set to the content provider 105. In step S408, the content provider 105 uses the returned tag set to create an optimized page. When the search engine 106 requests the page for the content provider 105, it is served with the set of pages which have been created to be adapted to the different typical contexts. If the search engine 106 caches the content, this will mean there will be caches of the adapted pages.

In step S409, the user of the user device 101 requests a search. Note that this is shown as the same user about whom user information is reported; however this is not necessarily the case, and is only for convenience of illustration. The user sends a request to the metasearch provider 107. Alternatively, the user may send a request to the search engine 106, in which case the following steps S410 to S414 are omitted and the search engine 106 returns searched pages to the user device 101.

In step S410, the metasearch provider 107 may request and receive the user information about the user requesting the search from the PNAS 103. If the request from the user device 101 includes the user information, the metasearch provider 107 may use this user information for the search. Further optimizations may include permissions (using a policy mechanism), predicated tag generation, optimization of search results predicated on commercial information (i.e. advertising).

In step S411, the metasearch provider 107 may send to the collection unit 203 the keywords included in the request from user device 101. The collection unit 203 manages the keywords as the user information and uses the keywords to send to the STOS 104 at step S404. This reporting from the metasearch provider 107 may be done either based on an ongoing subscription from the PNAS 103 to the metasearch provider 107; or using a push mechanism from the metasearch provider 107 to the PNAS 103; or the PNAS 103 making periodic requests for the information. In step S412, the metasearch provider 107 retrieves a number of pages from different search engines (only one search engine 106 is shown in FIG. 1 for simplicity). The metasearch provider 107 may include the user information retrieved at step S410 into the request. The pages are retrieved using the normal search method, which includes the keywords requested by the user device 101; and also potentially some or all of the user information. The more user context is included, the better the retrieval rate for the current user's context will be.

In step S413, the metasearch provider 107 computes the best fit for the query with the given user information, and adapts the presentation of the result to the user device 101, as presented in the Capabilities information which is included in the user information. This step may also involve other filtering, like removing duplicate pages, pages which are of little interest to the user given his personal profile (e.g. pages about military animals if the user searched on “Navy Seal”, and similar semantic filtering).

In step S414, the metasearch provider 107 returns the resulting list of retrieved pages to the user device 101. The steps described in FIG. 4 may be iterated frequently to continue improving the search engine optimization.

According to this embodiment, the content provider can create pages which will fit a search that is predicated on context, thus ending up at a high rating in the users search list irrespective of the search engine not being aware of the context which the user is likely to use. This embodiment also can provide static pages to the search engine, which are indexed in the normal way, but when retrieved by the metasearch provider those static pages can be further adapted and filtered to deliver a page that is a more precise fit with the users situation, based on the user information. This embodiment also enables more precisely targeted advertising to mobile telephones using established search engine optimization techniques. This embodiment can further provide a better fit of the retrieved results for the user, thus enabling a better user experience.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1.-10. (canceled)

11. A system for assisting a user with searching multimedia objects through at least one search engine, comprising:
a collection unit configured to collect sets of user information from more than one user device, each set of user information including both of context information associated with a user device and usage information associated with actions taken by a user of the user device;
a computation unit configured to compute statistics based on the collected sets of user information;
a reception unit configured to receive a multimedia object from a content provider;
a creation unit configured to create meta-information based on the computed statistics and the received multimedia object, the meta-information configured to be used by the at least one search engine to index the received multimedia object;
a response unit configured to respond to the content provider with the created meta-information;
a Metasearch Provider configured to:
receive a request from a first user device for searching multimedia objects;
in response to the request, return multimedia objects from the at least one search engine to the first user device;
wherein the Metasearch Provider retrieves, from the collection unit, a set of user information corresponding to the first user device;
wherein the Metasearch Provider sends, to at least one search engine, both keywords included in the request from the first user device and the retrieved set of user information corresponding to the first user device.

12. The system according to claim 11:
further comprising a determination unit configured to determine typical contexts which are user information having higher frequency of occurrence among the computed statistics;
wherein the creation unit is configured to create the meta-information based on the computed statistics and determined typical contexts.

13. The system according to claim 11:
wherein the reception unit is configured to receive capabilities of the content provider;
wherein the creation unit is configured to create the meta-information further based on the received capabilities.

14. The system according to claim 11:
wherein the Metasearch Provider is configured to send keywords included in the request to the collection unit;
wherein the collection unit is configured to manage the keywords as user information.

15. The system according to claim 11:
wherein the collection unit and the computation unit are included in a Personal Network Application Server;
wherein the reception unit, the creation unit, and the response unit are included in a Semantic Tag Optimization Server.

16. A method for assisting a user with searching multimedia objects through at least one search engine, comprising the steps of:
collecting sets of user information from more than one user device, each set of user information including both of context information associated with a user device and usage information associated with actions taken by a user of the user device;
computing statistics based on the collected sets of user information;
receiving a multimedia object from a content provider;
creating meta-information based on the computed statistics and the received multimedia object, the meta-information configured to be used by the at least one search engine to index the received multimedia object;
responding to the content provider with the created meta-information;
receiving, from a first user device, a request for searching multimedia objects;
retrieving a set of user information corresponding to the first user device;
sending, to the at least one search engine, both keywords included in the request from the first user device and the retrieved set of user information corresponding to the first user device;
returning multimedia objects from the at least one search engine to the user device.

17. A computer program product stored in a non-transient medium, which, when run on a computer causes the computer to execute software code that provides a method for assisting a user with searching multimedia objects through at least one search engine, the method comprising the steps of;
collecting sets of user information from more than one user device, each set of user information including both of context information associated with a user device and usage information associated with actions taken by a user of the user device;
computing statistics based on the collected sets of user information;
receiving a multimedia object from a content provider;
creating meta-information based on the computed statistics and the received multimedia object, the meta-information configured to be used by the at least one search engine to index the received multimedia object;
responding to the content provider with the created meta-information;
receiving a request for searching multimedia objects from a first user device;
retrieving a set of user information corresponding to the first user device;
sending, to the at least one search engine, both keywords included in the request from the user device and the retrieved set of user information corresponding to the first user device;
returning multimedia objects from the at least one search engine to the user device.
